(19) United States
(12) Patent Application Publication
(10) Pub. No.: US 2015/0118671 A1
(43) Pub. Date: Apr. 30, 2015

(54) Systems and Methods for Designing, Parsing and Mining of Game Log Files

(71) Applicant: Educational Testing Service, Princeton, NJ (US)

(72) Inventors: Jiangang Hao, Princeton, NJ (US); Alina von Davier, Lawrenceville, NJ (US); Robert J. Mislevy, Severna Park, MD (US); Lawrence L Smith, III, Rockville, MD (US)

(21) Appl. No.: 14/527,591

(22) Filed: Oct. 29, 2014

Related U.S. Application Data
(60) Provisional application No. 61/896,808, filed on Oct. 29, 2013.

(51) Int. Cl. G09B 5/00; G09B 9/00; G06F 17/30

(52) U.S. Cl. CPC G09B 5/00; G06F 17/30312; G09B 9/00
USPC 434/353; 434/322

(57) ABSTRACT

Exemplary data structures designed for log files of game/simulation-based educational assessments are described. An exemplary data structure may comprise at least one session element representing an assessee's participation in an educational assessment session; a session identification element identifying the educational assessment session represented by the session element; an assessee identification element identifying the assessee participating in the educational assessment session represented by the session element; an events element representing a collection of events occurring in the educational assessment session represented by the session element; an event element representing one event in the collection of events; an event time element indicting a time associated with the event; an event performer element indicating a performer of the event; an event target element indicating a target of the event; and an event result element representing a result of the event. Systems and methods for verifying log file conformance to the schema are described.

### CROSS-REFERENCE TO RELATED APPLICATIONS

The present application claims from the benefit of U.S. Provisional Application Ser. No. 61/896,808, entitled “Designing, Parsing and Mining of Game Log Files,” filed Oct. 29, 2013, the entirety of which is hereby incorporated by reference.

### FIELD

This disclosure is related generally to game/simulation-based assessment and more particularly to the design, parsing, and mining of information in game/simulation log files for educational assessment purposes.

### BACKGROUND

Game/Simulation-based assessment (G/SBA) has a number of advantages over traditional assessment, and is widely considered as an important future direction for assessments. A player's progress through the game/simulation is typically recorded in a log file for subsequent assessment. The log file thus plays a central role in reconstructing the player's performances in the game/simulation and is the major source of information for generating an assessment score.

Analyzing a G/SBA log file typically involves parsing for relevant information therein and extracting performance indicators therefrom. However, these tasks are often complicated by sub-optimal log file structures. For example, a log file may be a chronological information dump, lacking any defined structure, from the game/simulation. To make matters worse, some log files, in addition to including information related to performance assessment, also include troubleshooting information to be used by software developers to debug the game/simulation. The lack of a well-designed information structure and the inclusion of extraneous data irrelevant to the assessment make the task of mining for information within such log files inefficient. Moreover, the lack of structure also makes it difficult to implement generic analysis tools for such log files.

### SUMMARY

According to one aspect, exemplary data structures designed for log files of game/simulation-based educational assessments are described. In some embodiments the data structure may have predefined structured elements where some are static and some are extensible by developers of the assessment tools to include additional user-defined elements that is in a format specified by the log file data structure. The data structure would guide developers to output properly formed log files that include all the information useful in educational or proficiency assessments.

According to one example, a data structure is described. An exemplary data structure may comprise at least one session element representing an assessee's participation in an educational assessment session; a session identification element identifying the educational assessment session represented by the session element; an assessee identification element identifying the assessee participating in the educational assessment session represented by the session element; an events element representing a collection of events occurring in the educational assessment session represented by the session element; an event element representing one event in the collection of events; an event time element indicting a time associated with the event; an event performer element indicating a performer of the event; an event target element indicating a target of the event; and an event result element representing a result of the event.

According to another aspect, a method for assessing whether a data structure of a log file conforms to a schema is described. The method comprises receiving a log file containing data and identifying a data structure in which the data is recorded in the log file. The method further comprises determining whether the data structure elements of the log file properly correspond to predetermined structured elements of a schema, the schema including: at least one session element representing an assessee's participation in an educational assessment session; a session identification element, which is a child element of the session element, identifying the educational assessment session represented by the session element; an assessee identification element, which is a child element of the session element, identifying the assessee participating in the educational assessment session represented by the session element; an events element, which is a child element of the session element, representing a collection of events occurring in the educational assessment session represented by the session element; at least one event element, each of which is a child element of the events element representing one event in the collection of events; an event time element, which is a child element of the event element, indicting a time associated with the event represented by the event element; an event performer element, which is a child element of the event element, indicating a performer of the event represented by the event element; an event target element, which is a child element of the event element, indicating a target of the event represented by the event element; and an event result element, which is a child element of the event element, representing a result of the event represented by the event element. If the data structure elements of the log file properly correspond to the predetermined structural elements of the schema, a message flag is generated to indicate that the log file is suitable for further analysis of information relating to the assessee's performance on the educational assessment. If the data structure elements of the log file do not properly correspond to the predetermined structural elements of the schema, a message flag is generated to indicate that the log file is not suitable for further analysis of information relating to the assessee's performance on the educational assessment.

According to another aspect, an exemplary a method of logging and analyzing progress made within a game-based or simulation-based educational assessment is described. The method comprises accessing a schema with predefined structured elements, the predefined structural elements including: at least one session element representing an assessee's participation in an educational assessment session; a session identification element, which is a child element of the session element, identifying the educational assessment session represented by the session element; an assessee identification element, which is a child element of the session element, identifying the assessee participating in the educational assessment session represented by the session element; an events element, which is a child element of the session element, representing a collection of events occurring in the educational assessment session represented by the session element; at least one event element, each of which is a child element of the events element representing one event in the collection of events; an event time element, which is a child element of the event element, indicting a time associated with the event represented by the event element; an event performer element, which is a child element of the event element, indicating a performer of the event represented by the event element; an event target element, which is a child element of the event element, indicating a target of the event represented by the event element; and an event result element, which is a child element of the event element, representing a result of the event represented by the event element. The method further comprising receiving a log file for an assessee's participation in the educational assessment and verifying whether the log file conforms to the schema by determining whether data in the log file are structured corresponding to the predetermined structured elements of the schema. The log file may be analyzed using the predefined structured elements of the schema to synthesize information from the log file relating to the assessee's performance, and a result may be generated to indicate the assessee's performance on the educational assessment based on the synthesized information.

### BRIEF DESCRIPTION OF THE DRAWINGS

FIG. 1 is a block diagram depicting an embodiment of a game/simulation log analysis package integrated with a game/simulation-based leaning assessment.

FIG. 2 is an exemplary data structure defined by the game/simulation log analysis package.

FIG. 3 is a block diagram depicting aspects of an embodiment of a game/simulation log analysis package integrated with a game/simulation-based leaning assessment.

FIGS. 4A, 4B, and 4C depict example systems for use in implementing a game/simulation-based educational assessment that uses a game/simulation log analysis package.

### DETAILED DESCRIPTION

The present invention describes a game/simulation log analysis package (hereinafter “LAP”) that addresses several shortcomings of the conventional game/simulation based assessment framework. In general, the package provides a programming framework with a well-defined data structure for structuring log files and a library of software tools/functions for analyzing and visualizing in-game events. The design of the data structure, which dictates the structure of well-formed log files, is important in allowing the tools/functions to operate efficiently. With such an analysis package, psychometricians can liberate themselves from the non-trivial tasks of designing, generating, and extracting information from log files, and instead focus their work on designing assessment rubrics.

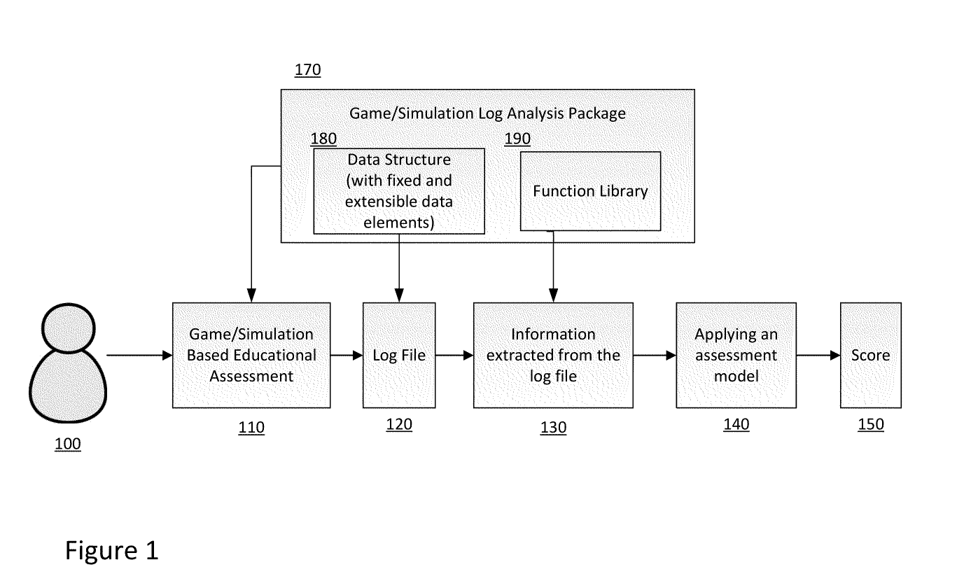

FIG. 1 depicts an exemplary process flow for a game/simulation-based educational assessment 110 utilizing LAP 170. An assessee 100 may participate in a game/simulation-based educational assessment 110, which is an assessment administered via a simulated or virtual interactive space. The simulation/game may provide a simulated scenario where a participating assessee's interactions therein may seem continuous and the simulation/game would respond according to a large state machine. As the assessee progresses through the game/simulation, events in the game/simulation may be recorded in a log file 120 in accordance with a data structure 180 defined by LAP (e.g., the data structure may be implemented using an XML schema). The data structure 180 may include predetermined data elements as well as extensible data elements that allow assessment designers to define his own data elements. Once the assessee finishes the assessment 110 and the log file 120 is complete, the next step in the assessment process may be to analyze the log file 120 to extract information or find evidence indicative of the assessee's performance. Extractions of information 130 (e.g., event patterns, statistical information, etc.) from the log file 120, which may be validated against the LAP's predefined schema 180, may be performed by functions provided in the LAP's function library 190. The information extracted 130 may then be used by an assessment model 140 to generate an assessment score 150 for the assessee 100.

A data structure is a description of how data elements are structured and what the data types are for each element. For the same amount of information, there can be many different data structures, depending on how much details one wants to include. Generally speaking, the elements in the data structure can be classified as “atomic” and composite. Atomic elements refer to the part of the data that cannot be reduced further while the composite elements refer to the part of the data that can be derived from other parts of the data. Thus, in implementations where the goal is to specify a concise yet complete data structure, the data structure should be defined using atomic elements since other composite elements can be derived later on in the processing stage. It is worth noting that there are some elements that cannot be easily constructed based on data later on, but rather easy to be recorded during the game/simulation. In some implementations, such elements would be treated as atomic elements.

In terms of data space/dimensions, the possibilities are infinite in games/simulations. However, given that the LAP is designed to be used for game/simulation-based educational assessment, the types of data elements logged may focus on those that are relevant for assessment purposes. This constraint narrows down the possible data space significantly and allows a concise yet complete data structure to be defined for most of the game/simulation-based assessment tools. In some implementations, this data sub-space may be further narrowed based on known characteristics of the game/simulation and assessment metrics. For example, if an embodiment of the LAP is designed for single player games/simulations (rather than multi-player), the data structure may be structured accordingly under that assumption. If the assessment is designed to gather a certain kind of evidence of assessees' ability, the data structure may be designed for recording that evidence. Such assumptions and considerations serve to filter out many complex processes that may not be relevant for assessment purposes.

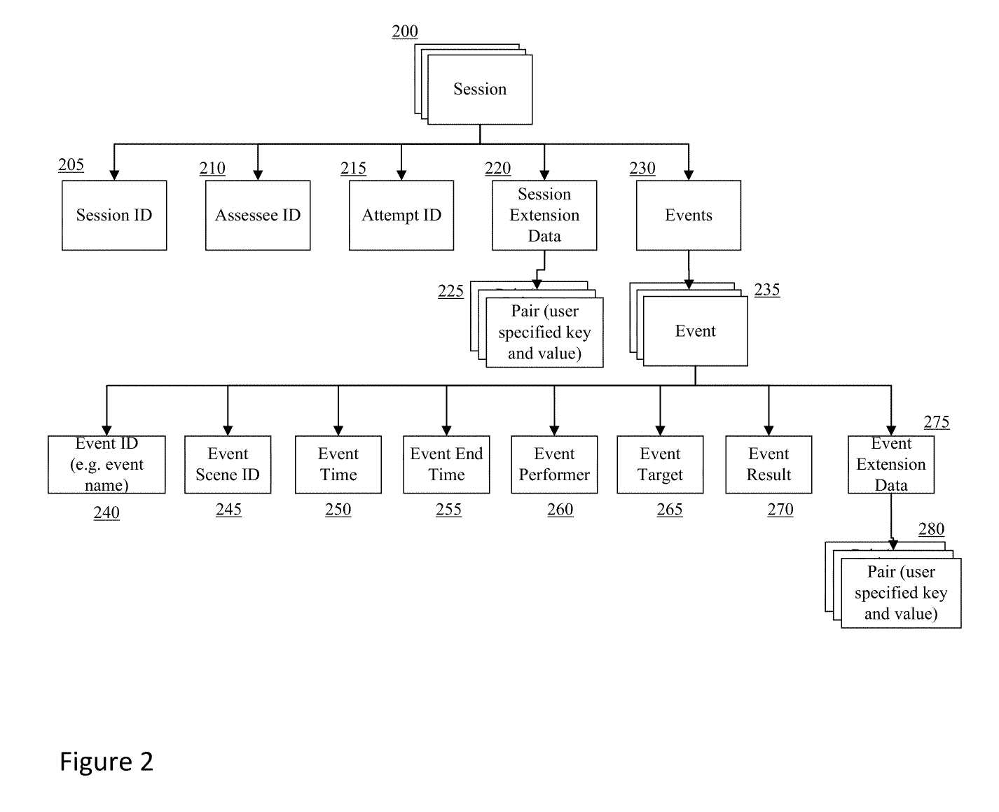

FIG. 2 depicts an exemplary data structure for a LAP log file that includes a concise and complete set of predefined structured data elements. In this example, the basic unit for analysis is defined to be a Session 200, which represents each time an assessee participates in the game/simulation. The Session 200 may therefore be identified by a child element/subfield, Session ID 205 and an Assessee ID 210. In addition, since an assessee may attempt playing the game/simulation multiple times, an Attempt ID 215 may also be included as a child element/subfield in the data structure to track that information.

During a gaming/simulation session, the assessee may encounter/trigger/experience a collection of events, represented in the data structure by the Events node 230. The Events node 230 may include any number of child Event nodes 235, each representing a single event. The type of event may be identified or characterized by an Event ID 240 (e.g., a code identifying the event, an event name, an event description, and/or the like). In some implementations, each Event 235 may also have a child Event Scene ID 245 to identify the particular game/simulation context in which the event took place (e.g., the level, stage, quest, location, and/or the like). Rather than an identification code, the Event Scene ID 245 may alternatively be described textually (e.g., “Hallway”), and/or it may be further specified by several child elements, such as the location's spatial coordinates (e.g., x-position, y-position, and z-position). An event may have an Event Time 250 (e.g., a start time) and, where applicable, an Event End Time 255 (e.g., the Event End Time 255 may be set to an invalid time value or the same time as the Event Time 250 to indicate that no end time is applicable). An Event 235 may have an Event Performer 260 as a child element, which specifies the person, character, thing, etc., that triggered or caused the event. For example, the Event Performer 260 may be the assessee (e.g., the assessee opening a door), a character in the game/simulation (e.g., a boss asking a question or attacking), the game/simulation system (e.g., the system giving the assessee a new gaming objective), or any other trigger of an event. The Event 235 may also have a child element Event Target 265, which is the person, character, thing, etc., that the Event 235 is directed towards. For example, when an assessee opens a door, the Event Target 265 may be the door; when a boss asks the assessee a question, the Event Target 265 may be the assessee; when the system gives the assessee a new gaming objective, the Event Target 265 may again be the assessee. If the particular event does not have an Event Target 265, the data field may be left unspecified or a predetermined value may be given to indicate that no Event Target 265 is applicable. The Event 235 may also include an Event Result 270 child element, which as the name suggests is the result of the Event 235. For example, the assessee opening a door may result in the door being opened or failing to open; the boss asking a question may result in the assessee answering the question correctly or incorrectly; the system giving a new game objective result in the assessee accepting, denying, or requesting another objective. Each of the data elements described above may itself have one or more elements/attributes to further specify or define the element. For example, the Event Performer 260 may have one or more child elements/subfields in case there may be one or more events performs that caused the event. Similarly, the Event Target 265 may also have child elements/subfields to accommodate situations where an event has multiple targets. Since an Event 235 may have multiple results, the Event Result 270 element may also have multiple child elements.

The above described elements all have predefined data types. However, each assessment developer using the LAP may have its unique data requirements or interests. To accommodate the potential unknown needs of users, the LAP data structure also includes elements that allow a user to specify his own data types. In some implementations, the LAP data mode may include extensible elements that allow users to define custom elements at the session level and at the event level. For example, if the user wants to specify data elements at the session level, he may define one or more key-value pairs 225 under a predefined data element called Session Extension Data 220. In some implementations, each key-value pair 225 may include a Pair element that has two child elements, a Key element and a Value element. For example, if a session developer wants to log a session's duration, he may do so by having his game/simulation output a session key-value pair 225 with “SessionDuration” as the “key” element, and whatever the actual duration of a session as the “value” element. Similarly, if the user wants to specify data elements at the event level, he may do so using the Event Extension Data element 275 under the Event element 235. The Event Extension Data element 275 also may have one or more key-value pairs 280 that can be used to log user-specified data types. For example, if an assessment developer wishes to track the status of an opponent during an event, he may design his game/simulation such that it outputs an event key-value pair 280 with “Opponent Status” as the “key” and a numerical status indication as the associated “value.”

The definition of the data structure depicted in FIG. 2 may be implemented, for example, using an Extensible Markup Language (hereinafter “XML”) schema. The schema, in turn, describes the structure of valid XML documents, which in this case would be the log files. An example of an XML log file is provided below:

```
<?xml version=″1.0″ encoding=″iso88591″?>
  <gameLog xsi=>
    <session>
      <sessionID> 123 </sessionID>
      <assesseeID> John Doe </assesseeID>
      <attemptID> 1 </attemptID>
      <sessionExtData>
        <pair>
          <key> Country </key>
          <value> USA </value>
        </pair>
        <pair>
          <key> State </key>
          <value> NY </value>
        </pair>
        ....
      </sessionExtData>
    <events>
      <event>
        <eventID> open </eventID>
        <eventScene> hotel </eventScene>
        <eventTime> 2014-01-01 10:20:36 </eventTime>
        <eventEndTime> 2014-01-01 10:22:46 </eventEndTime>
        <eventPerformer> assessee </eventPerformer>
        <eventTarget> hotel room door </eventTarget>
        <eventResult>
          <pair>
            <key> door status </key>
            <value> opened </value>
          </pair>
          <pair>
            <key> player location </key>
            <value> hotel room </value>
          </pair>
          ...
        </eventResult>
        <eventExtData>
          <pair>
            <key> previous location </key>
            <value> airport </value>
          </pair>
          ...
        </eventExtData>
      </event>
      <event>
        ...
      </event>
      ...
    </events>
  </session>
  <session>
    <sessionID> 124 </sessionID>
    <ssesseeID> John Doe </assesseeID>
    <attemptID> 2 </attemptID>
    ...
  </session>
  <session>
    ...
  </session>
  ...
</gameLog>
```

It is worth noting that while the data elements are described using XML elements, one of ordinary skill in the art would recognize that XML attributes may be used instead. For example, Session ID 205 may be an attribute of the Session element 200. At a more general level, an XML element or attribute of an XML schema may be referred to as a data field of a data structure or data structure. Just as an XML element may have child element, a field may have a subfield.

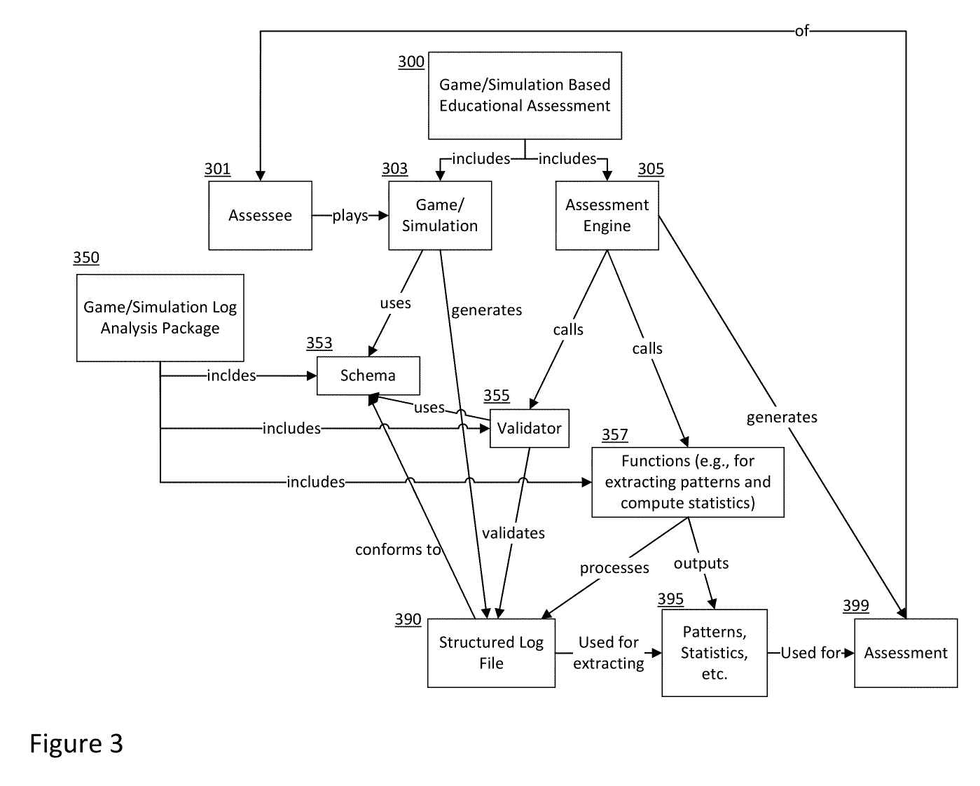

FIG. 3 provides a block diagram showing how an embodiment of the LAP may be used by a game/simulation-based educational assessment tool. The game/simulation-based educational assessment tool 300 may include a game/simulation component 303 and an assessment engine 305. The game/simulation log analysis package (i.e., LAP) 350 may include a schema 353 as described above, an XML validator 355, and one or more functions 357, which will be described further below.

When an assessee 301 plays the game/simulation 303, the game/simulation 303 may use the LAP's schema definition 353 to generate a structured log file 390. The data structure of the log file 390 should conform to the schema 353 definition. Once the assessee completes the game/simulation 303 (or completes a session) and a corresponding log file 390 has been output, the assessment engine 305 may then assess the assessee's 301 performance based on the log file 390. In some implementations, the assessment engine 305 may call the LAP's validator 355 to validate/verify that the log file 390 conforms to the schema 353. In some other implementations, the assessment engine may use its own validator to perform substantially the same task. For example, when a log file is received, the validator may identify a data structure in which the data is recorded in the log file, and then determine whether the data structure elements of the log file properly correspond to predetermined structured elements of the schema. If the data structure elements of the log file do not properly correspond to the schema, then the validator may generate a message flag indicating that no further analysis may be performed on the received log file (e.g., no further extraction of information from the log file). On the other hand, if the data structure elements of the log file do properly correspond to the schema, then the validator may generate message flag indicating that further analysis may be performed. The message flag may be a Boolean indicator, which other methods/functions of the game/simulation-based educational assessment may use to determine whether to proceed with analysis of the log file.

Once the log file 390 has been validated/verified, the assessment engine 305 may use any one of the LAP functions 357 to process the structured log file 390 and synthesize information 395 therefrom. The functions 357 assume that the log file 390 it processes is a valid (i.e., conforms to the XML schema definition 353). Since the structure of the XML log file 390 is known, the functions 357 may be implemented to efficiently extract data from the file. For example, one function 357 may output the frequency of particular event n-grams. An n-gram may be defined as consecutive sequence of n events. For example, a tri-gram event may be a user answering three questions correctly twice, followed by an incorrect answer. Such n-gram may be found by analyzing the event ID (e.g., to identify events related to the assessee's actions in the game/simulation environment), event performer (e.g., to identify events performed by the assessee), and/or event result (e.g., to determine whether a certain kind of building/structure has been correctly added to a simulated situation). Occurrences of the n-gram pattern in the log file 390 may be counted and a frequency of occurrences 395 may be output by the function 357. As another example, a function 357 may match a given event sequence to the event sequences within the log file 390 and calculate an edit distance (i.e., a numeric measure representing the degree of difference between the given sequence and the observed sequence). Another function 357 may find a specified event sequence from the entire list of events. A function 357 may also perform filtering operations, such as filtering the events by a specified time tolerance before and/or after a given event. The functions 357 may also perform statistical analysis. For example, the functions 357 may perform auto-correlation analysis, Fourier analysis, and other event-time series analysis, as well as clustering events by their temporal separation. These functions may be implemented using any conventionally known programming language, such as Python, Java, C++, Pearl, etc.

By using the LAP functions 357, the assessment engine 305 may efficiently synthesize information 395 from the log file 390 without having to implement the functions itself. The extracted synthesized information 395 may then be used by any assessment model defined by the assessment engine 305 to generate an assessment 399 result indicative of the assessee's 301 performance on the educational assessment. Generating the assessment 399 result may be accomplished, for example, by scoring individual aspects of the assessee's performance, such as the accuracy in completing the task, the time it took to complete the task, whether the assessee utilized any built in assistance through help functions to complete the task, etc., and then combining those individual scores into an overall score, which may be represented as a simple point value or a percentage of available points, for instance. The assessment 399 result may then be outputted (e.g., displayed, printed, electronically communicated, etc.) to an assessment administrator, the assessee, a teacher, a data store, etc.

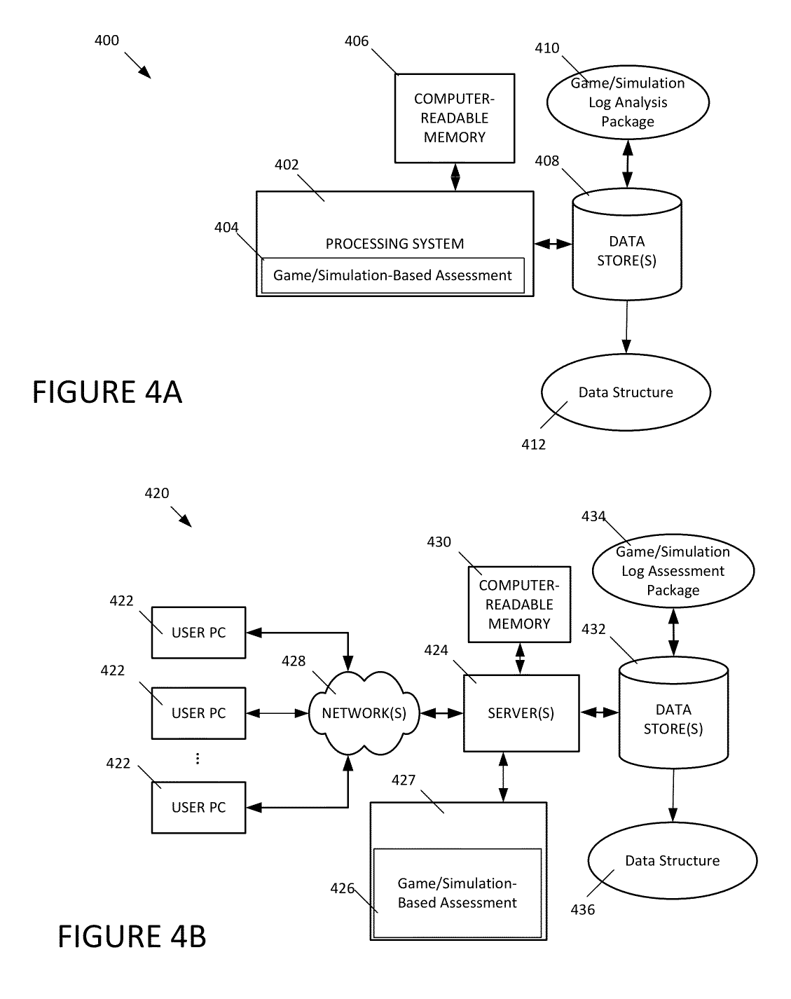

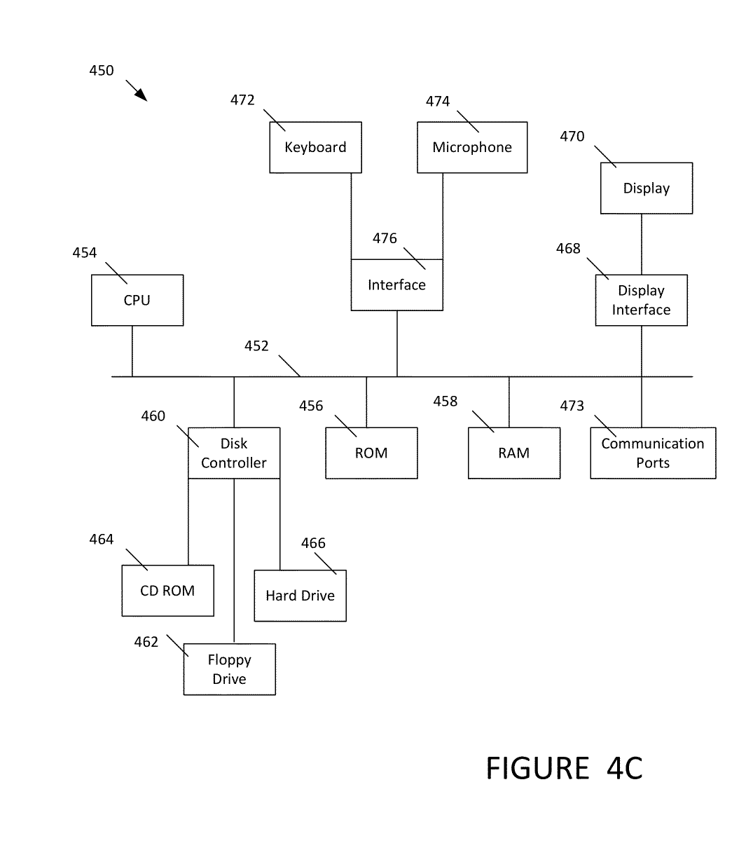

Additional examples will now be described with regard to additional exemplary aspects of implementation of the approaches described herein. FIGS. 4A, 4B, and 4C depict example systems for use in implementing a retrieval system described herein. For example, FIG. 4A depicts an exemplary system 400 that includes a standalone computer architecture where a processing system 402 (e.g., one or more computer processors located in a given computer or in multiple computers that may be separate and distinct from one another) includes a game/simulation-based assessment 404 being executed on it. The processing system 402 has access to a computer-readable memory 406 in addition to one or more data stores 408. The one or more data stores 408 may include the game/simulation-based log analysis package 410 as well as a predefined data structure/schema 412.

FIG. 4B depicts a system 420 that includes a client server architecture. One or more user PCs 422 access one or more servers 424 running a game/simulation-based assessment 426 on a processing system 427 via one or more networks 428. The one or more servers 424 may access a computer readable memory 430 as well as one or more data stores 432. The one or more data stores 432 may contain the game/simulation log assessment package 434 as well as a predefined data structure/schema 436.

FIG. 4C shows a block diagram of exemplary hardware for a standalone computer architecture 450, such as the architecture depicted in FIG. 4A that may be used to contain and/or implement the program instructions of system embodiments of the present invention. A bus 452 may serve as the information highway interconnecting the other illustrated components of the hardware. A processing system 454 labeled CPU (central processing unit) (e.g., one or more computer processors at a given computer or at multiple computers), may perform calculations and logic operations required to execute a program. A non-transitory processor-readable storage medium, such as read only memory (ROM) 456 and random access memory (RAM) 458, may be in communication with the processing system 454 and may contain one or more programming instructions for the game/simulation-based assessment and the game/simulation log analysis package. Optionally, program instructions may be stored on a non-transitory computer readable storage medium such as a magnetic disk, optical disk, recordable memory device, flash memory, or other physical storage medium.

A disk controller 460 interfaces one or more optional disk drives to the system bus 452. These disk drives may be external or internal floppy disk drives such as 462, external or internal CD-ROM, CD-R, CD-RW or DVD drives such as 464, or external or internal hard drives 466. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 460, the ROM 456 and/or the RAM 458. Preferably, the processor 454 may access each component as required.

A display interface 468 may permit information from the bus 452 to be displayed on a display 470 in audio, graphic, or alphanumeric format. Communication with external devices may optionally occur using various communication ports 473.

In addition to the standard computer-type components, the hardware may also include data input devices, such as a keyboard 472, or other input device 474, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as Python, Pearl, C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable multimedia for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A non-transitory computer memory storing a data structure defining data elements and their relationships in a log file from a game-based or simulation-based educational assessment, the data structure comprising:
at least one session element representing an assessee's participation in an educational assessment session;
a session identification element, which is a child element of the session element, identifying the educational assessment session represented by the session element;
an assessee identification element, which is a child element of the session element, identifying the assessee participating in the educational assessment session represented by the session element;
an events element, which is a child element of the session element, representing a collection of events occurring in the educational assessment session represented by the session element;
at least one event element, each of which is a child element of the events element representing one event in the collection of events;
an event time element, which is a child element of the event element, indicting a time associated with the event represented by the event element;
an event performer element, which is a child element of the event element, indicating a performer of the event represented by the event element;
an event target element, which is a child element of the event element, indicating a target of the event represented by the event element; and
an event result element, which is a child element of the event element, representing a result of the event represented by the event element.

2. The non-transitory computer memory storing the data structure of claim 1, the data structure further comprising:
a session extension data element, which is a child element of the session element, allowing a user to specify additional data types for the educational assessment session represented by the session element;
a data pair element, which is a child element of the session extension data element;
a key element, which is a child element of the data pair element; and
a value element, which is a child element of the data pair element;
wherein the session extension data element is defined to include one or more data pair elements, each of which representing a user-defined data type, specified using the associated key element, and a corresponding data value for that data type, specified using the associated value element.

3. The non-transitory computer memory storing the data structure of claim 1, the data structure further comprising:
an event extension data element, which is a child element of the event element, allowing a user to specify additional data types for the event represented by the event element;
a data pair element, which is a child element of the event extension data element;
a key element, which is a child element of the data pair element; and
a value element, which is a child element of the data pair element;
wherein the event extension data element is defined to include one or more data pair elements, each of which representing a user-defined data type, specified using the associated key element, and a corresponding data value for that data type, specified using the associated value element.

4. The non-transitory computer memory storing the data structure of claim 1, wherein the data structure further includes an attempt identification element, which is a child element of the session element, identifying an attempt of the assessee participating in the educational assessment session represented by the session element.

5. The non-transitory computer memory storing the data structure of claim 1, wherein the data structure further includes an event identification element, which is a child element of the event element, identifying the event represented by the event element.

6. The non-transitory computer memory storing the data structure of claim 1, wherein the event time indicates a start time of the event, and wherein the data structure further includes an event end time element, which is a child element of the event element, indicting an end time of the event represented by the event element.

7. The non-transitory computer memory storing the data structure of claim 1, wherein the data structure further includes an event scene element, which is a child element of the event element, identifying a virtual scene within the educational assessment session where the event represented by the event element occurred.

8. A non-transitory computer-readable medium encoded with instructions for logging and analyzing progress made within a game-based or simulation-based educational assessment, the instructions when executed causing a processing system to execute steps comprising:
accessing a schema with predefined structured elements, the predefined structural elements including:
at least one session element representing an assessee's participation in an educational assessment session;
a session identification element, which is a child element of the session element, identifying the educational assessment session represented by the session element;
an assessee identification element, which is a child element of the session element, identifying the assessee participating in the educational assessment session represented by the session element;
an events element, which is a child element of the session element, representing a collection of events occurring in the educational assessment session represented by the session element;
at least one event element, each of which is a child element of the events element representing one event in the collection of events;
an event time element, which is a child element of the event element, indicting a time associated with the event represented by the event element;
an event performer element, which is a child element of the event element, indicating a performer of the event represented by the event element;
an event target element, which is a child element of the event element, indicating a target of the event represented by the event element; and
an event result element, which is a child element of the event element, representing a result of the event represented by the event element;
receiving a log file for an assessee's participation in the educational assessment;
verifying whether the log file conforms to the schema by determining whether data in the log file are structured corresponding to the predetermined structured elements of the schema;
analyzing the log file using the predefined structured elements of the schema to synthesize information from the log file relating to the assessee's performance, and
generating a result indicative of the assessee's performance on the educational assessment based on the synthesized information.

9. The non-transitory computer-readable medium of claim 8, wherein analyzing the log file includes identifying an event pattern in the log file.

10. The non-transitory computer-readable medium of claim 9, wherein identifying an event pattern in the log file includes identifying a sequence of one or more events in the log file.

11. The non-transitory computer-readable medium of claim 8, wherein analyzing the log file includes computing an event statistic from the log file.

12. The non-transitory computer-readable medium of claim 11, wherein computing the event statistic includes aggregating information related to one or more events.

13. A computer-implemented method for logging and analyzing progress made within a game-based or simulation-based educational assessment, comprising:
accessing a schema with predefined structured elements, the predefined structural elements including:
at least one session element representing an assessee's participation in an educational assessment session;
a session identification element, which is a child element of the session element, identifying the educational assessment session represented by the session element;
an assessee identification element, which is a child element of the session element, identifying the assessee participating in the educational assessment session represented by the session element;
an events element, which is a child element of the session element, representing a collection of events occurring in the educational assessment session represented by the session element;
at least one event element, each of which is a child element of the events element representing one event in the collection of events;
an event time element, which is a child element of the event element, indicting a time associated with the event represented by the event element;
an event performer element, which is a child element of the event element, indicating a performer of the event represented by the event element;
an event target element, which is a child element of the event element, indicating a target of the event represented by the event element; and
an event result element, which is a child element of the event element, representing a result of the event represented by the event element;
receiving a log file for an assessee's participation in the educational assessment;
verifying whether the log file conforms to the schema by determining whether data in the log file are structured corresponding to the predetermined structured elements of the schema;
analyzing the log file using the predefined structured elements of the schema to synthesize information from the log file relating to the assessee's performance, and
generating a result indicative of the assessee's performance on the educational assessment based on the synthesized information.

14. The computer-implemented method of claim 13, wherein analyzing the log file includes identifying an event pattern in the log file.

15. The computer-implemented method of claim 14, wherein identifying an event pattern in the log file includes identifying a sequence of one or more events in the log file.

16. The computer-implemented method of claim 13, wherein analyzing the log file includes computing an event statistic from the log file.

17. The computer-implemented method of claim 16, wherein computing the event statistic includes aggregating information related to one or more events.

18. A system for logging and analyzing progress made within a game-based or simulation-based educational assessment, comprising:
a processing system; and
a memory coupled to the processing system, wherein the processing system is configured to execute steps, comprising:
accessing a schema with predefined structured elements, the predefined structural elements including:
at least one session element representing an assessee's participation in an educational assessment session;
a session identification element, which is a child element of the session element, identifying the educational assessment session represented by the session element;
an assessee identification element, which is a child element of the session element, identifying the assessee participating in the educational assessment session represented by the session element;
an events element, which is a child element of the session element, representing a collection of events occurring in the educational assessment session represented by the session element;
at least one event element, each of which is a child element of the events element representing one event in the collection of events;
an event time element, which is a child element of the event element, indicting a time associated with the event represented by the event element;
an event performer element, which is a child element of the event element, indicating a performer of the event represented by the event element;
an event target element, which is a child element of the event element, indicating a target of the event represented by the event element; and
an event result element, which is a child element of the event element, representing a result of the event represented by the event element;
receiving a log file for an assessee's participation in the educational assessment;
verifying whether the log file conforms to the schema by determining whether data in the log file are structured corresponding to the predetermined structured elements of the schema;
analyzing the log file using the predefined structured elements of the schema to synthesize information from the log file relating to the assessee's performance, and
generating a result indicative of the assessee's performance on the educational assessment based on the synthesized information.

19. The system of claim 18, wherein analyzing the log file includes identifying an event pattern in the log file.

20. The system of claim 19, wherein identifying an event pattern in the log file includes identifying a sequence of one or more events in the log file.

21. The system of claim 18, wherein analyzing the log file includes computing an event statistic from the log file.

22. The system of claim 21, wherein computing the event statistic includes aggregating information related to one or more events.

23. A method for assessing whether a data structure of a log file of an assessee's participation in an educational assessment conforms to a schema for, comprising:
receiving a log file containing data;
identifying a data structure in which the data is recorded in the log file, the data structure including a plurality of data structure elements;
determining whether the data structure elements of the log file properly correspond to predetermined structured elements of a schema, the schema including:
at least one session element representing an assessee's participation in an educational assessment session;
a session identification element, which is a child element of the session element, identifying the educational assessment session represented by the session element;
an assessee identification element, which is a child element of the session element, identifying the assessee participating in the educational assessment session represented by the session element;
an events element, which is a child element of the session element, representing a collection of events occurring in the educational assessment session represented by the session element;
at least one event element, each of which is a child element of the events element representing one event in the collection of events;
an event time element, which is a child element of the event element, indicting a time associated with the event represented by the event element;
an event performer element, which is a child element of the event element, indicating a performer of the event represented by the event element;
an event target element, which is a child element of the event element, indicating a target of the event represented by the event element; and
an event result element, which is a child element of the event element, representing a result of the event represented by the event element;
if the data structure elements of the log file properly correspond to the predetermined structural elements of the schema, generating a message flag that the log file is suitable for further analysis of information relating to the assessee's performance on the educational assessment; and
if the data structure elements of the log file do not properly correspond to the predetermined structural elements of the schema, generating a message flag that the log file is not suitable for further analysis of information relating to the assessee's performance on the educational assessment.
